(19) United States
(12) Patent Application Publication
(10) Pub. No.: US 2019/0024978 A1
(43) Pub. Date: Jan. 24, 2019

(54) DRILL BIT, TAP HOLE DRILLING MACHINE EQUIPPED WITH SAID DRILL BIT, AND PROCESS FOR MAKING SAID DRILL BIT

(71) Applicant: ArcelorMittal, Luxembourg (LU)

(72) Inventors: Sheila DIAZ VAQUERO, Gijon, Asturia (ES); Juan Jose FERNANDEZ LOPEZ, NAVIA, ASTURIAS (ES)

(21) Appl. No.: 16/067,240

(22) PCT Filed: Dec. 27, 2016
(86) PCT No.: PCT/IB2016/058020

§ 371 Date: Jun. 29, 2018

(30) Foreign Application Priority Data
Dec. 29, 2015 (IB) PCT/IB2015/002426

(51) Int. Cl. F27D 3/15; C21B 7/12; B22F 3/105

(52) U.S. Cl. CPC F27D 3/1527; B22F 2005/001; B22F 3/1055; C21B 7/125

(57) ABSTRACT

A drill bit for improving performance of a drilling machine is provided. The drill bit includes a drill bit body with a rear end adapted to be connected to a drilling machine, and a leading end with a flat face perpendicular to a longitudinal axis (X-X) of the drill bit body. The drill bit body includes a first tapered portion with diameters increasing from the flat face of the leading end to a maximum diameter (Dmax), a second tapered portion with diameters decreasing from the maximum diameter (Dmax) to the rear end of the drill body, at least three partly-circular recesses formed in the drill bit body thus delimitating as many tapered drilling faces, each of them extending from the flat face of the leading end to the maximum diameter (Dmax). The flat face and the tapered drilling faces have a plurality of protruding teeth and the teeth are cylindrical and have a longitudinal axis (Y-Y) forming an angle with the face supporting the teeth which is less than or equal to 90°.

The invention primarily relates to a drill bit for use in a tap hole drilling machine for producing a molten material, such as iron, in a blast furnace molten material making process.

The present invention also relates to a tap hole drilling machine equipped with said drill bit, and to a method for making said drill bit.

### BACKGROUND

Generally, in the blast furnace operation, a plurality of tap holes which are formed on the bottom of a blast furnace are either periodically drilled by using a tap hole drilling machine, or the tap holes are drilled by hitting by means of a hammer. Then a slag and a molten iron are tapped through the tap hole. After the molten iron is tapped, the hole is refilled with refractory material.

The tap holes are variously different depending on the blast furnace, but generally the depth from the blast furnace shell to the inner region of the blast furnace is about 3 m.

In blast furnaces, for the draining of the main trough and skimmer, there is usually a dedicated drilling machine. This machine is very expensive (about 500 k€) and is used during many years. With the time, the power of the drilling machine usually decreases. Therefore, there is a need for providing a drill bit with improved efficiency for old drilling machine.

### BRIEF SUMMARY

The invention relates to drill bit for a tap hole drilling machine.

Particularly, the present invention relates to a drill bit, and a tap hole drilling machine, in which a large quantity of chips could be generated and evacuated during the drilling operation so that the refractory material of the tap hole can be speedily drilled, thereby efficiently carrying out the tap hole drilling operation.

Furthermore, since a drilling machine usually requires a lot of energy, there is also a need for a drill bit with improved efficiency in order to reduce the energy consumption of new drilling machines.

Since improving the drilling efficiency of a drill bit could save energy, it also could save time by allowing the drilling of a wider tap hole. The molten material tapping time can then be reduced.

An object of the invention is to provide a drill bit able to improve performance of old drilling machine.

Another object of the invention is to provide a drill bit able to reduce the need of power of a drilling machine in order to save energy for the same effect.

Another object of the invention is to provide a drill bit able to reduce the time needed for tapping the molted material out of the blast furnace.

The present invention provides a drill bit for use in a tap hole drilling machine, said drill bit comprising a drill bit body with a rear end adapted to be connected to a leading end of a drill rod of the tap hole drilling machine, and a leading end with a flat face perpendicular to a longitudinal axis of the drill bit body, said drill bit body comprising:
a first tapered portion with diameters increasing from the flat face of the leading end to a maximum diameter,
a second tapered portion with diameters decreasing from the maximum diameter to the rear end of said drill body,
at least three partly-circular recesses formed in said drill bit body thus delimitating as many tapered drilling faces, each of them extending from the flat face of the leading end to the maximum diameter,
   wherein the flat face and the tapered drilling faces have a plurality of protruding teeth, and
   wherein the teeth are cylindrical and have a longitudinal axis forming an angle α with the face supporting the teeth which is less than or equal to 90°.

The drill bit of the invention may also comprise the following optional characteristics considered in isolation or according to all possible technical combinations:
some teeth have the longitudinal axis forming an angle α with the face supporting the teeth which is equal to 90° and some teeth have the longitudinal axis forming an angle α with the face supporting the teeth which is less than 90°.
the angle α which is less than 90° is comprised between 45 and 89°.
some teeth have a flat leading face perpendicular to the longitudinal axis and some teeth have a flat leading face forming an angle with the longitudinal axis which is less than 90°.
the teeth having their longitudinal axis forming an angle α with their supporting face which is less than 90° are inclined according different directions from each other.
each tapered drilling faces has at least three teeth.
each tapered drilling faces have five teeth and wherein the flat face has three teeth.
the drill bit may have further comprise an air flow path consisting of a straight blind passage formed along a central longitudinal axis of the drill bit body, and of as many inclined passages as tapered drilling faces, said inclined passages extending between the straight blind passage and the flat face of the leading end; and/or
each inclined passage leads to an opening facing one tapered drilling faces, and each tooth of the flat face is located facing one partly-circular recess.

The invention also provides a tap hole drilling machine equipped with a drill bit according to the invention.

The invention also provides a method for making a drill bit according to the invention, said method being a three dimensional printing process.

The three dimensional printing process may be operated with a fiber laser able to melt fine metal powder, said fine metal powder being a Nickel based alloy referenced UNS N07718.

The invention also provides a computer assisted design file which comprises digital information for the implementation of the method when loaded onto a three-dimensional printer.

### BRIEF DESCRIPTION OF THE FIGURES

Other characteristics and advantages of the invention will emerge clearly from the description of it that is given below by way of an indication and which is in no way restrictive, with reference to the appended figures in which:

FIG. 1 is a schematic perspective representation of a drill bit according to the invention,

FIG. 2 is a schematic plan representation seen from above of the drill bit of FIG. 1, showing the distribution of the teeth and their orientation,

FIG. 3 is a schematic perspective representation of a straight cylindrical tooth of the drill bit according to the invention,

FIG. 4 is a schematic perspective representation of an inclined cylindrical tooth of the drill bit according to the invention,

FIG. 5 is a schematic perspective representation of a beveled cylindrical tooth of the drill bit according to the invention,

FIG. 6 is a schematic sectioned representation of a drill bit according to the invention, showing the air flow path for cooling the drill bit and evacuating the chips generated by the drilling operation, and

FIG. 7 is a photography of the drill bit of FIG. 1 seen from below, showing the inner screw diameter to connect the drill bit to a leading end of a drill rod of a tap hole drilling machine.

### DETAILED DESCRIPTION

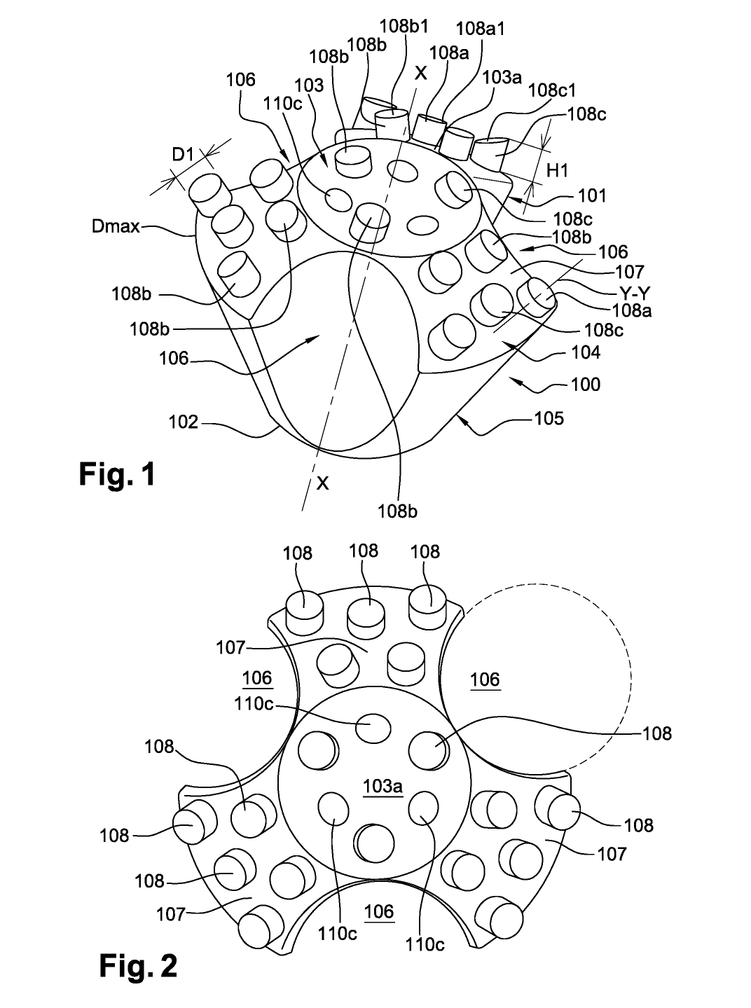

An embodiment of the drill bit according to the invention is illustrated in FIGS. 1 and 2. The drill bit 100 comprises a drill bit body 101 with a rear end 102 (see FIGS. 6 and 7) adapted to be connected to a leading end of a drill rod of the tap hole drilling machine, and a leading end 103 with a flat face 103a perpendicular to a longitudinal axis X-X of the drill bit body 101.

The drill bit body 101 comprises a first tapered portion 104 with diameters increasing from the flat face 103a of the leading end 103 to a maximum diameter Dmax (see FIG. 6), and a second tapered portion 105 with diameters decreasing from the maximum diameter Dmax to the rear end 102 of said drill body 101. Such first tapered portion 104 and second tapered portion 105 are more visible on the sectioned representation of FIG. 6.

The drill bit body 101 further comprises three partly-circular recesses 106 formed in said drill bit body thus delimitating three tapered and inclined drilling faces 107, each of them extending from the flat face 103a of the leading end 103 to the maximum diameter Dmax.

According to other embodiments, the drill bit body comprises more than three partly-circular recesses 106, thus delimitating as many tapered drilling faces 107.

The partly-circular recesses 106 are partly cylindrical and parallel to the longitudinal axis X-X of the drill bit body 101. This can be seen on FIGS. 2 and 6.

On FIG. 2, the drill bit 100 is seen from the above, and the partly-circular recesses 106 are empty. In other words, it is not possible to see parts of the drill bit body 101 through the partly-circular recesses 106 when seen from the above.

On FIG. 6, straight dashed lines 106a materialize the partly-circular recesses 106. As it can be seen, the straight dashed lines 106a are parallel to the longitudinal axis X-X of the drill bit body 101.

This improve the ability of the drill bit to evacuate the chips generated by the drilling operation.

The flat face 103a and the tapered drilling faces 107 have a plurality of teeth 108.

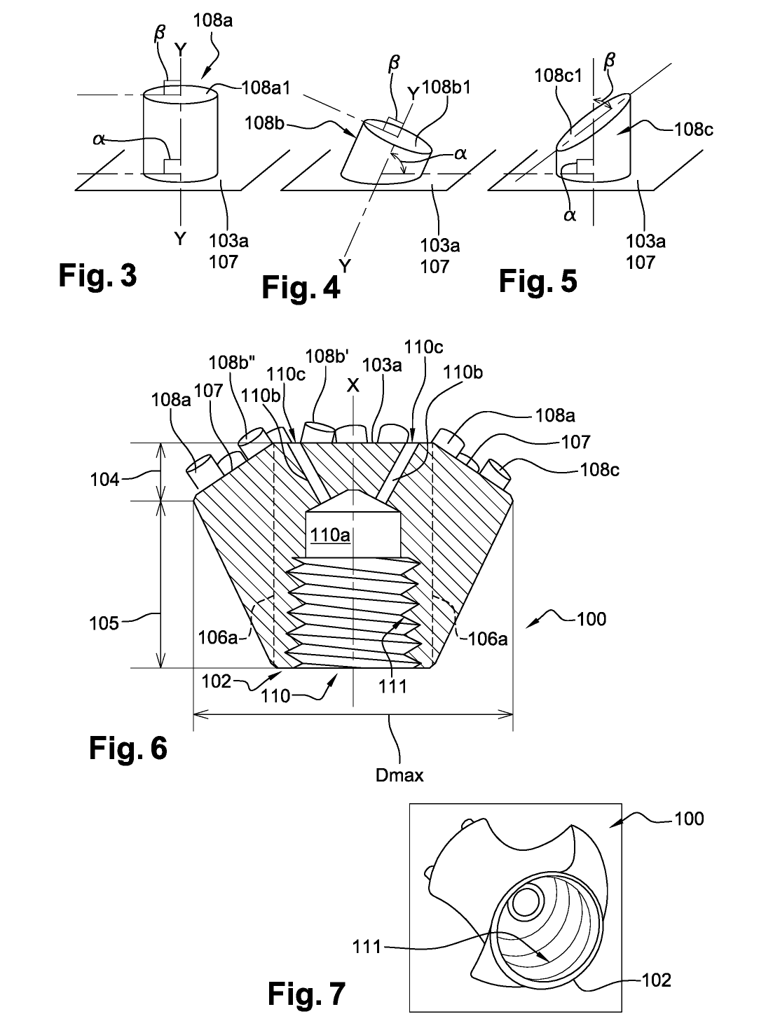

As it can be seen on the diagrammatic representation from the front of FIG. 2, each tooth 108 is cylindrical and has a longitudinal axis Y-Y (see FIGS. 3, 4 and 5). The advantages of the cylindrical teeth 108,108a,108b,108c is that there is more contact surface between the drill bit and the refractory material.

Depending on the tooth, its longitudinal axis Y-Y forms an angle α with its supporting face (the face supporting the tooth) 103a or 107, said angle α being preferably less than or equal to 90°.

On FIG. 3, the longitudinal axis Y-Y of a first type of tooth 108a forms an angle α of 90° with the face supporting the tooth (103a or 107).

Referring to FIG. 4, a second type of tooth 108b is inclined relative to the perpendicular of the face supporting the tooth 103a or 107. In other words, the second type of tooth 108b has a longitudinal axis Y-Y forming an angle α with its supporting face 103a or 107 preferably comprised between 20° and 89° and more preferably comprised between 45° and 89°. In FIG. 4, the second type of tooth 108b has a longitudinal axis Y-Y forming an angle α of about 60° with the face supporting the tooth 103a or 107.

On FIGS. 3 and 4, the first and second type of teeth 108a and 108b have a flat leading face 108a1,108b1 perpendicular to the longitudinal axis Y-Y.

Therefore, the first type of teeth 108a has a longitudinal axis Y-Y forming an angle α of 90° with the face supporting the tooth 103a or 107, and a flat leading face 108a1 perpendicular to the longitudinal axis Y-Y. And the second type of teeth 108b has a longitudinal axis Y-Y forming an angle α less than 90° (for example of 60°) with the face supporting the tooth 103a or 107, and a flat leading face 108a1 perpendicular to the longitudinal axis Y-Y.

On FIG. 5, the third type of teeth 108c is beveled, it means that it has a flat leading face 108c1 forming an angle β with the longitudinal axis Y-Y less than 90° while, in the example of FIG. 5, its longitudinal axis Y-Y forms an angle α of 90° with the face supporting the tooth 103a or 107

Of course, it is possible to combine the embodiments of FIGS. 3 and 5 (straight and beveled tooth), and FIGS. 4 and 5 (inclined and beveled tooth) for forming other types of teeth, for example an inclined and beveled type of teeth (combination of FIGS. 4 and 5).

As shown on FIGS. 1 and 6, a plurality of teeth 108,108a,108b,108c are mounted on each tapered drilling faces 107. In this example, each tapered drilling faces 107 comprises five teeth 108,108a,108b,108c and the flat face 103a comprise three teeth 108,108a,108b,108c. Of course, the number of teeth is adapted depending on the area of the tapered drilling faces 107 and of the flat face 103a, but it remains important to have more than one tooth on each tapered drilling face 107 and flat face 103a, and most preferably more than three teeth on each tapered drilling face 107. An optimal performance of drilling is obtained with these large number of cylindrical teeth 108,108a,108b, 108c on each drilling and flat face 107,103a in contact with the refractory material to be removed.

Moreover, on each drilling face 107 and flat face 103a, the teeth are of different types according to the above description illustrated on FIGS. 3, 4 and 5. Therefore, the teeth 108,108a,108b,108c of each face 107, 103a have either several inclinations with its supporting face 103a or 107 and/or their flat leading face 108a1, 108b1,108c1 form an angle β with the longitudinal axis Y-Y of the corresponding tooth 108a,108b,108c of 90° or less than 90°. Since the drill bit according to the invention may comprise inclined teeth in various directions and beveled teeth with various orientations of the flat leading face, many undercuts are generated.

The combination of first, second and third types of teeth 108a,108b,108c (and possibly other types of teeth resulting from the combination of the first, second and third types of teeth 108a,108b, 108c) on the drilling faces 107,103a together with the large number of cylindrical teeth 108, 108a,108b,108c on each drilling face 107,103a increases considerably the performances of the drilling operation (and makes it easier) because the drill bit may attack the refractory material in an increased number of points with different angles of attack.

The drill bit according to the invention further comprises an air flow path 110 consisting of a straight blind passage 110a formed along the central longitudinal axis X-X of the drill bit body 101, and of as many inclined passages 110b as tapered drilling faces 107.

The straight blind passage 110a comprises an internal thread 111 to connect the drill bit to a leading end of a drill rod of a tap hole drilling machine.

The inclined passages 110b extend between the straight blind passage 110a and the flat face 103a of the leading end 103.

On the example, the drill bit according to the invention comprises three inclined passages 110b, since it comprises three tapered drilling faces 107.

Each inclined passages 110b lead to an opening 110c facing one tapered drilling faces 107 while each tooth 108 of the flat face 103a is located facing one partly-circular recess (106). In other words, the openings 110c do not face the partly-circular recesses 106. This allows to remove chips from the teeth and to evacuate these chips towards the partly-circular recesses 106 in operation, when air is flown through the air flow path 110. Moreover, the circular configuration of the openings 110c of the three inclined passages 110b makes it possible to have several teeth 108 mounted on the flat face 103a of the leading end 103 (which acts as a real drilling face and also allows the removing of the chips) and on the three drilling faces 107. The number (three in this example) of inclined passages 110b (and corresponding openings 110c) allows having an uniform distribution of the blown air then optimizing the removing of the chips.

Due to the geometry of the teeth, the partly-circular recesses 106 and the openings 110c, the drilling effect is improved. As explained above, the number and the geometry of the teeth 108,108a,108b,108c increase the performances of material removal. And the number and configuration of inclined passages 100b and openings 110c increase the capacity of removing chips via the partly-circular recesses 106. Therefore, the refractory material is drilled faster and the chips are faster and better extracted. Thus, it is possible to increase the diameter of the drill bit regarding to drill bit of the state of art. The diameter of the tap hole is increased from 50 mm (state of art) to 80 mm with the invention.

With the invention, it is now possible to clean the main trough and skimmer in about 20 seconds, when the same operation with a state of art drill bit took up to 6 minutes.

According to the invention, the method for making the drill bit described here before is a three-dimensional printing process. The term three-dimensional printing process relates to an additive method of manufacture in three dimensions.

The drill bit according to the invention is made of metal, preferably Inconel 718® (Special Metals Corporation), a Nickel based alloy referenced UNS N07718.

The three dimensional printing process is operated with a three-dimensional printer having a fiber laser able to melt fine metal powder. Such 3D-printer may be an EOS M280 ® made by EOS GmbH (Electro Optical Systems GmbH).

The fine metal powder used for making the drill bit according to the invention is preferably Inconel 718® (Special Metals Corporation), a Nickel based alloy referenced UNS N07718.

In order to make the drill bit according to the invention with a 3D printer, it is necessary to create a computer assisted design file comprising all the geometrical features of the drill bit according to the invention for operating a three-dimensional printer to implement the method describe here before.

Thus a computer assisted design file is made which, when loaded into a three-dimensional printer, comprises digital information which allows a three-dimensional print-out of the drill bit of the invention as described here before to be made.

In these conditions, the manufacturing time is of 14 hours for one to five drill bit body instead of several days for casting methods of the prior art.

Thanks to the 3D printing method according to the invention it is possible to manufacture a drill bit according to the invention with many undercuts.

Furthermore, since the teeth 108 are integrally formed with the drill bit body 101, and are not added (screwed or welded) on said drill bit body, the drill bit according to the invention is more resistant than drill bits of the state of art presenting added teeth.

What is claimed is:

1-13. (canceled)

14: A drill bit for a tap hole drilling machine, the drill bit comprising:
a drill bit body comprising:
a rear end for connecting to a leading end of a drill rod of a tap hole drilling machine;
a leading end with a flat face perpendicular to a longitudinal axis (X-X) of the drill bit body;
a first tapered portion with diameters increasing from the flat face of the leading end to a maximum diameter (Dmax);
a second tapered portion with diameters decreasing from the maximum diameter (Dmax) to the rear end of the drill body;
at least three recesses formed in the drill bit body delimitating as many tapered drilling faces, each of the tapered drilling faces extending from the flat face of the leading end to the maximum diameter (Dmax);
the flat face and the tapered drilling faces having a plurality of protruding teeth, the teeth being cylindrical and having a longitudinal axis (Y-Y) forming an angle (α) with the face supporting the teeth, the angle (α) being less than or equal to 90°.

15: The drill bit according to claim 14, wherein at least one of the protruding teeth has the longitudinal axis (Y-Y) forming an angle (α) with the face supporting the teeth which is equal to 90° and at least one of the protruding teeth has the longitudinal axis (Y-Y) forming an angle (α) with the face supporting the teeth which is less than 90°.

16: The drill bit according to claim 15, wherein the angle (α) which is less than 90° is between 45 and 89°.

17: The drill bit according to claim 15, wherein at least one of the protruding teeth has a flat leading face perpendicular to the longitudinal axis (Y-Y) and at least one of the protruding teeth has a flat leading face forming an angle (β) with the longitudinal axis (Y-Y) which is less than 90°.

18: The drill bit according to claim 14, wherein at least two of the protruding teeth have the longitudinal axis (Y-Y) forming an angle (α) with the supporting face which is less than 90° and the longitudinal axes are inclined in different directions from each other.

19: The drill bit according to claim 14, wherein each tapered drilling face has at least three teeth.

20: The drill bit according to claim 14, wherein each tapered drilling face has five teeth and wherein the flat face has three teeth.

21: The drill bit according to claim 14, further comprising an air flow path including a straight blind passage formed along the longitudinal axis (X-X) of the drill bit body, and as many inclined passages as tapered drilling faces, the inclined passages extending between the straight blind passage and the flat face of the leading end.

22: The drill bit according to claim 21, wherein each inclined passage leads to an opening facing one tapered drilling face and wherein each tooth of the flat face is located facing one recess.

23: A tap hole drilling machine comprising:
a drill bit according to claim 14.

24: A method for making a drill bit according to claim 14, comprising the step of:
manufacturing the drill bit in three dimensions.

25: The method according to claim 24, wherein the manufacturing includes operating a fiber laser able to melt fine metal powder, the fine metal powder being a nickel-based alloy.

26: The method according to claim 25, wherein the nickel-based alloy is UNS N07718.

27: A computer assisted design file comprising digital information for the implementation of the method according to claim 24 when loaded onto a three-dimensional printer.

28: Computer readable media, having stored thereon, computer executable instructions for performing the method of claim 24.

29: The drill bit according to claim 14, wherein the at least three recesses are partly-circular.
